(19) United States
(12) Patent Application Publication
(10) Pub. No.: US 2007/0174033 A1
(43) Pub. Date: Jul. 26, 2007

(54) Remote control device and method for accessing peripheral device remotely

(75) Inventors: Ying-Tsai Huang, Taipei Hsien (TW); Tyng-Horng Tsai, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Aten International Co., Ltd.

(21) Appl. No.: 11/322,609

(22) Filed: Dec. 30, 2005

(51) Int. Cl. G06F 9/455

(52) U.S. Cl. 703/24

(57) ABSTRACT

A remote control device which makes a first computing device capable of accessing a peripheral device connected to a second computing device is disclosed. The remote control device has a network interface circuit, a peripheral device controller and a processor. The network interface circuit is capable of connection to the second computing device via a network. The peripheral device controller is electrically connected to the network interface circuit. The processor is electrically connected to the network interface circuit and the peripheral device controller, and the peripheral device is emulated for the first computing device according to device information of the peripheral device.

### BACKGROUND

1. Field of Invention

The present invention relates to a remote control device. More particularly, the present invention relates to a remote control device that can connect a local computing device to a remote computing device.

2. Description of Related Art

IT managers usually have to manage servers that are not located nearby, such as those on other floors or other sites. Remote control devices or remote management software is typically used to accomplish such remote management.

Sometimes, IT managers need to access or download files which are provided from a remote computing device rather than directly from the local server for system updating or system configuration of the local server. In this case, a file or data transfer from the remote computing device to the local server is required. If the operating system of the local server is still booted up, IT managers can duplicate the file or data from the remote computing device via a network according to the file transfer capability of the operating system.

However, some basic operations that are related to system configuration or hardware set up, such as updating BIOS, booting to DOS, and configuring on-board LAN chips or on-board SCSI chips, have to be run under a low-level operating system (e.g., DOS) instead of a high-level operating system (e.g. WINDOW). In other words, these tasks are difficult to accomplish without loading the high-level operating system supporting the file transfer capability, especially when the file must be obtained from a remote server via a network.

### SUMMARY

It is therefore an aspect of the present invention to provide a first computing device, which can access a peripheral device, such as a USB device, connected to a second computing device remotely via a network.

According to one preferred embodiment of the present invention, the first computing device has a network interface circuit, a peripheral device controller, a peripheral host controller and a processor. The network interface circuit is capable of connection to the second computing device via a network. The peripheral device controller is electrically connected to the network interface circuit. The peripheral host controller is electrically connected to the peripheral device controller. The processor is electrically connected to the network interface circuit and the peripheral device controller, and the peripheral device is emulated for the first computing device according to device information of the peripheral device defined by the protocol or the standard used on the interface between the peripheral device and the second computing device. That is, the first computing device is able to detect the presence of the peripheral device connected to the second computing device.

It is another aspect of the present invention to provide a remote control device, which can make a first computing device capable of accessing a peripheral device connected to a second computing device.

According to another preferred embodiment of the present invention, the remote control device has a network interface circuit, a peripheral device controller and a processor. The network interface circuit is capable of connection to the second computing device via a network. The peripheral device controller is electrically connected to the network interface circuit. The processor is electrically connected to the network interface circuit and the peripheral device controller, and a peripheral device is emulated for the first computing device according to device information of the peripheral device defined by the protocol or the standard used on the interface between the peripheral device and the second computing device.

It is still another aspect of the present invention to provide a method in which a peripheral device is emulated such that a first computing device can access the peripheral device physically connected to a second computing device via a network.

According to another preferred embodiment of the present invention, the peripheral device is connected to the second computing device by a peripheral interface. Device information of the peripheral device is received via a network. The peripheral device is emulated for the first computing device according to the device information defined by the peripheral interface.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic view of one preferred embodiment of the present invention FIG. 2 is a flow chart of another preferred embodiment of the present invention; and

FIG. 3 is a sequence flow of one preferred embodiment of the present invention.

### DESCRIPTION OF THE PREFERRED EMBODIMENTS

Reference is now made in detail to the preferred embodiments of the present invention, examples of which are illustrated in the accompanying drawings. Wherever possible, the same reference numbers are used in the drawings and the description to refer to the same or like parts.

The present invention emulates a peripheral device for a first computing device located locally, such as a local server, according to an actual peripheral device connected to a second computing device via a network. The local server can access the peripheral device as if the peripheral device directly connected thereto. Therefore, file transmission under a low-level operating system can be accomplished by the virtual peripheral device.

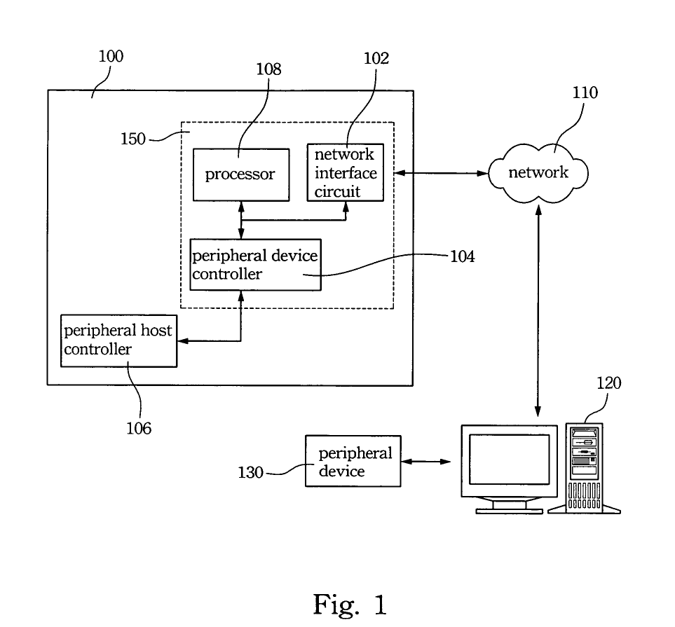

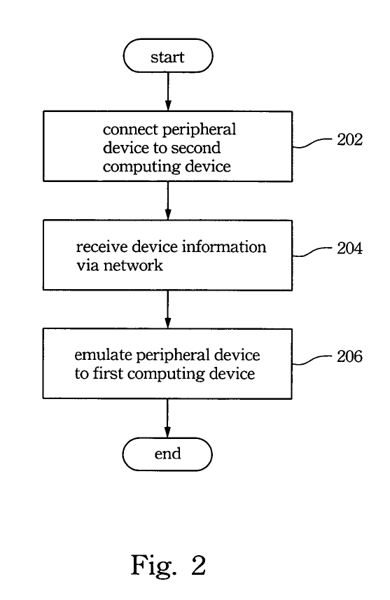

FIG. 1 is a schematic view of one preferred embodiment of the present invention. A first computing device 100 has a network interface circuit 102, a peripheral device controller 104, a peripheral host controller 106 and a processor 108. The network interface circuit 102 is capable of connection to a second computing device 120 via a network 110. The peripheral device controller 104 is electrically connected to the network interface circuit 102. The peripheral host controller 106 is electrically connected to the peripheral device controller 104. The processor 108 is electrically connected to the network interface circuit 102 and the peripheral device controller 104.

A peripheral device 130, which connected to the second computing device 120 rather than directly connected to the first computing device 100, is emulated for the first computing device 100 according to device information of the peripheral device 130 defined by the protocol or the standard used on the interface between the peripheral device and the second computing device 120. More particularly, the processor 108 receives the device information of the peripheral device 130 by the network interface circuit 102 via the network 110, and instructs the peripheral device controller 104 that the peripheral device 130 is thus emulated for the first computing device 100.

Intelligent Platform Management Interface capabilities are a key component in providing enterprise-class management for high-availability systems. The term “Intelligent Platform Management Interface” refers to autonomous monitoring and recovery features implemented directly in platform management hardware and firmware. In the preferred embodiment, the processor 108 is a baseboard management controller (BMC), which provides the intelligence behind Intelligent Platform Management Interface. The second computing device 120 further comprises an Intelligent Platform Management Interface (IPMI) management software installed therein. The peripheral host controller 106 can be integrated into or separate from a Southbridge chip or chipset on a motherboard, not shown in figures, of the first computing device 100.

The first computing device 100 can be a server, a workstation, a desktop personal computing device, a notebook personal computer or the like. The second computing device 120 can be a server, a workstation, a personal computing device, a notebook computer or the like. The network interface circuit 102, the peripheral device controller 104 and the processor 108 can be mounted on or integrated in a remote control device 150, such as an IPMI daughter board having a BMC formed thereon. Alternatively, the network interface circuit 102, the peripheral device controller 104 and the processor 108 can be separately configured in the first computing device 100. The network 110 can be a local area network (LAN), a wireless local area network (WLAN) or other communication network, for example, provided by a network hub or the like.

By the foregoing configuration, when the peripheral device 130 is a USB device, the IT manager can use the IPMI management software to transmit a “USB attach-in” instruction for the processor 108 (i.e., the BMC) on the first computing device 100. The processor 108 emulates an “attach-in” action of the peripheral device 130 to the first computing device 100. After initiation procedures defined by USB protocol, the first computing device 100 can detect and then communicate with the peripheral device 130. The first computing device 100 transmits a USB instruction or data request in a packet format to the IPMI management software of the second computing device 120 to access the actual peripheral device 130.

The IPMI management software parses the USB instruction and then makes response to the processor 108 on the first computing device 100, completing the USB instruction or data request.

That is, the peripheral device 130, which can be a USB device (such as a USB Floppy disc driver, a USB optical disc driver or a USB Disk), is emulated for the first computing device 100 to access. For the first computing device 100, it seems that there is a virtual USB device attached to its USB port, thus allowing access to files provided from the peripheral device 130 connected to the second computing device 120. Moreover, more than one peripheral device 130 connected on the same or different second computing devices 130, respectively, can be simultaneously emulated for the first computing device 100. In addition, the virtual peripheral device 130 does not occupy a physical USB connector of the first computing device 100, reserving more available peripheral interfaces of the first computing device 100 for connecting other peripheral devices.

The virtual peripheral device 130 can be used for system updating or system configuration of the first computing device 100, such as updating BIOS, booting to DOS, and configuring on-board LAN chips and on-board SCSI chip. For example, when the peripheral device 130 is a mass storage device defined by the USB protocol, the processor 108 can transmit an instruction, a request or data between the peripheral device controller 104 and the peripheral device 130. The peripheral host controller 106, which can be integrated into or separate from the Southbridge chip on a motherboard (not shown) of the first computing device 100, can access the peripheral device 130 connected to the second computing device 120 via the network 110, communicating with the peripheral device 130 through the peripheral device controller 104, the processor 108 and the network interface circuit 102. Therefore, the first computing device 100 can be rebooted by the processor 108 of the remote control device 150 remotely via the peripheral device 130.

In another aspect, the preferred embodiment discloses a remote control device 150, which can make the first computing device 100 capable of accessing the peripheral device 130 connected to the second computing device 120. The remote control device 150 has the network interface circuit 102, the peripheral device controller 104 and the processor 108. The network interface circuit 102 is capable of connection to the second computing device 120 via the network 110. The peripheral device controller 104 is electrically connected to the network interface circuit 102. The processor 108 is electrically connected to the network interface circuit 102 and the peripheral device controller 104, and the peripheral device 130 is emulated for the first computing device 100 according to device information of the peripheral device 130 defined by the protocol or the standard used on the interface between the peripheral device 130 and the second computing device 120.

The following description is made with reference to FIG. 1 and FIG. 2. FIG. 2 is a flow chart of another preferred embodiment of the present invention, in which a peripheral device 130 is emulated for a first computing device 100 shown in Fig.1. The peripheral device 130, such as a USB device, is connected to the second computing device 120 by a peripheral interface (step 202). Device information of the peripheral device 130, defined by the protocol used on the peripheral interface between the peripheral device 130 and the second computing device 120, is received by the processor 108 via the network 110 (step 204). The. peripheral device 130 is emulated for the first computing device 100 according to the device information defined by the peripheral interface (step 206).

More particularly, the device information is received by the processor 108, and the peripheral device 130 can be emulated by the processor 108, such as a baseboard management controller (BMC) (not shown) providing the intelligence behind Intelligent Platform Management. The second computing device 120 further comprises an Intelligent Platform Management Interface (IPMI) management software installed therein. The first computing device 100 can be a server, a workstation, a personal computing device, a notebook computer or the like. The second computing device 120 can be a server, a workstation, a desktop personal computing device, a notebook personal computer or the like. The network 110 can be a local area network (LAN), a wireless local area network (WLAN) or other communication network, for example, provided by a network hub or the like. The peripheral interface can be an IDE interface, a SCSI interface or a USB interface.

In the preferred embodiment, the peripheral device is a USB device. By the foregoing configuration, the IT manager can use the IPMI management software to transmit an “USB attach-in” instruction to the processor 108 (i.e. the BMC) on the first computing device 100. The processor 108 emulates an “attach-in” action of the peripheral device 130 to the first computing device 100. After initiation procedures defined by USB protocol, the first computing device 100 can detect and then communicate with the peripheral device 130. The first computing device 100 transmits a USB instruction or data request in a packet format to the IPMI management software of the second computing device 120 to access the actual peripheral device 130.

The IPMI management software parses the USB instruction and then makes response to the processor 108 on the first computing device 100, completing the USB instruction or data request.

That is, the peripheral device 130, such as a USB Floppy disc driver, a USB optical disc driver or a USB Disk, can be emulated for the first computing device 100 to access. For the first computing device 100, it seems that there is a virtual USB device attached to its USB port, thus allowing access to files provided from the peripheral device 130 connected to the second computing device 120. Moreover, more than one peripheral device 130 connected on the same or different second computing devices 130, respectively, can be simultaneously emulated for the first computing device 100. In addition, the virtual USB device does not occupy a physical USB connector of the first computing device 100, thus freeing peripheral interfaces of the first computing device 100 for connecting other peripheral devices.

The virtual peripheral device 130 can be used for system updating or system configuration of the first computing device 100, such as updating BIOS, booting to DOS, and configuring on-board LAN chips and on-board SCSI chips. For example, when the peripheral device 130 is a mass storage device defined by USB protocol, the processor 108 can transmit an instruction, a request or data between the peripheral device controller 104 and the peripheral device 130. The peripheral host controller 106, which can be integrated into or separate from a Southbridge chip on a motherboard, not shown, of the first computing device 100, can access the peripheral device 130 connected to the second computing device 120 via the network 110, communicating with the peripheral device 130 through the peripheral device controller 104. Therefore, the first computing device 100 can be rebooted by the processor 108 of the remote control device 150 remotely via the peripheral device 130.

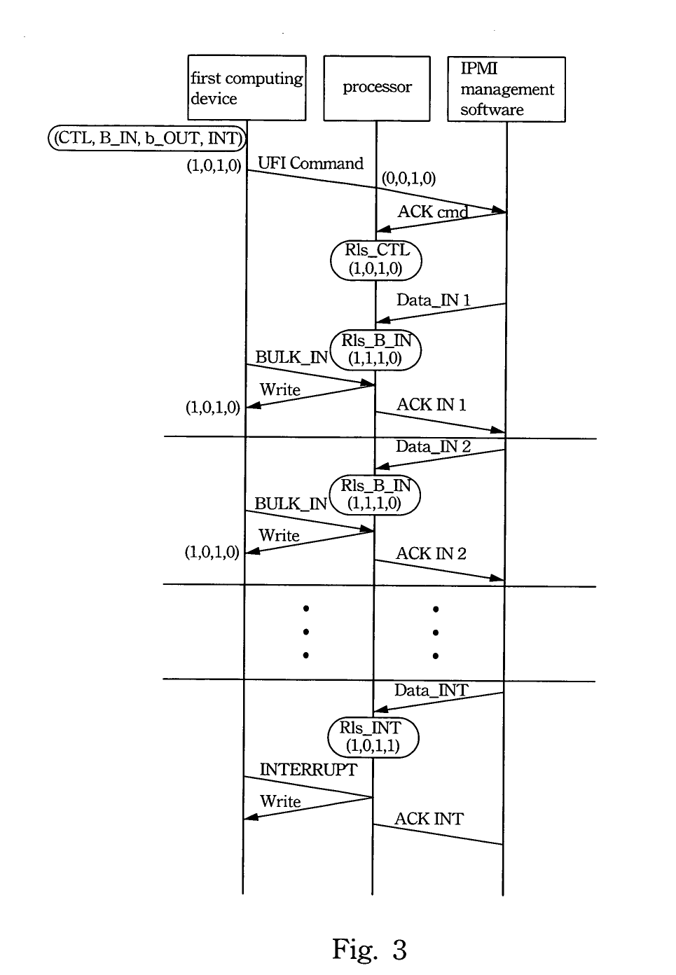

FIG. 3 is a sequence flow of one preferred embodiment of the present invention, illustrating the sequence between the first computing device 100, the processor 108 and the IPMI management software installed in the second computing device 120 for BULK_IN information.

At the beginning, the first computing device 100 transmits a UFI command to the IPMI management software through the processor 108. The IPMI management transmits an ACK command to the processor 108 in response to the UFI command, and then transmits Data_IN 1 to the processor 108. After the first computing device 100 transmits BULK_IN to the processor 108, the processor 108 writes Data_IN 1 to the first computing device 100 and transmits ACK_IN 1 to the IPMI management software.

By repeating the above sequence, the data stored in the peripheral device 130 connected to the second computing device 120 via the network 110 can be accessed by the first computing device 100, thus creating a virtual USB device connected to the first computing device 100.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computing device, capable of accessing a peripheral device connected to a second computing device, the computing device comprising:
a network interface circuit capable of connection to the second computing device via a network,
a peripheral device controller electrically connected to the network interface circuit;
a peripheral host controller electrically connected to the peripheral device controller; and
a processor electrically connected to the network interface circuit and the peripheral device controller, wherein the peripheral device is emulated for the computing device.

2. The computing device as claimed in claim 1, wherein the processor is a baseboard management controller.

3. The computing device as claimed in claim 2, wherein the second computing device further comprises an Intelligent Platform Management Interface management software.

4. The computing device as claimed in claim 1, wherein the peripheral host controller is integrated into a Southbridge chip.

5. The computing device as claimed in claim 1, wherein the peripheral host controller is arranged to access the peripheral device connected to the second computing device via the network.

6. The computing device as claimed in claim 1, wherein the peripheral host controller is arranged to communicate with the peripheral device through the peripheral device controller.

7. The computing device as claimed in claim 1, wherein when the peripheral device is a storage device, the processor is arranged to transmit an instruction and data between the peripheral device controller and the peripheral device.

8. A remote control device, making a first computing device capable of accessing a peripheral device connected to a second computing device, the remote control device comprising:
a network interface circuit capable of connection to the second computing device via a network,
a peripheral device controller electrically connected to the network interface circuit; and
a processor electrically connected to the network interface circuit and the peripheral device controller, wherein the peripheral device is emulated for the first computing device.

9. The remote control device as claimed in claim 8, wherein the processor is a baseboard management controller.

10. The remote control device as claimed in claim 8, wherein the second computing device further comprises an Intelligent Platform Management Interface management software.

11. The remote control device as claimed in claim 8, wherein the peripheral device controller is arranged to communicate with the first computing device and the peripheral device.

12. The remote control device as claimed in claim 8, wherein when the peripheral device is a storage device, the processor is arranged to transmit an instruction and data between the peripheral device controller and the peripheral device.

13. A method for allowing a first computing device to access a peripheral device connected to a second computing device, comprising the steps of:
connecting the peripheral device to the second computing device by a peripheral interface;
receiving device information of the peripheral device defined by the peripheral interface between the peripheral device and second computing device via a network; and
emulating the peripheral device for the first computing device according to the device information.

14. The method as claimed in claim 13, wherein the device information is received and the peripheral device is emulated by a baseboard management controller.

15. The method as claimed in claim 13, wherein the peripheral interface is chosen from a group consisting of an IDE interface, a SCSI interface and a USB interface.
